(19) United States
(12) Patent Application Publication
(10) Pub. No.: US 2010/0100456 A1
(43) Pub. Date: Apr. 22, 2010

(54) CELL ONTOGENY INFORMATION SYSTEMS AND METHODS OF USING THE SAME

(76) Inventor: Michael West, Mill Valley, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/407,611

(22) Filed: Mar. 19, 2009

Related U.S. Application Data
(60) Provisional application No. 61/038,000, filed on Mar. 19, 2008.

(51) Int. Cl. G06Q 30/00; G06F 3/048

(52) U.S. Cl. 705/27; 715/764

(57) ABSTRACT

Aspects of the invention are drawn to cell ontogeny information systems and methods for using the same.

### CROSS REFERENCE

This application claims the benefit under 35 U.S.C.§119(e) of provisional patent application Ser. No. 61/038,000, entitled “Cell Ontogeny Information Systems and Methods for Using the Same” filed Mar. 19, 2008, the entirety of which is incorporated herein by reference.

### BACKGROUND

Embryonic stem (ES) cells are pluripotent stem cells that are able to differentiate into all somatic cell lineages. The complexity of cell types that can be obtained from ES cells is greater than a hundred-fold, and considering the subtle differences in gene expression that result from site-specific homeobox gene expression (such as HOX gene expression) and subtle but important changes that occur continuously over time in the developing embryo or the corresponding differentiating ES cells in vitro, the complexity rises into the thousand-fold. Since both research and therapeutic uses of the cells requires a rigorous understanding of the molecular markers of identity of the cell lineages that arise out of hES cell cultures as well as methods to differentiate and purify lineage-specific cells (such as the use of cell surface antigens), there is a need for a database to provide researchers with a detailed cellular ontogeny of development from ES cell to all adult cells.

The present invention meets this, and other, needs.

### SUMMARY OF THE INVENTION

Aspects of the present invention include a cell ontogeny information system that includes:
(a) a relational database comprising cell ontogeny information for a plurality of distinct cell types of an organism, wherein the cell ontogeny information for each of the plurality of distinct cell types comprises:
   (i) a developmental age of the organism; and
   (ii) one or more genes expressed in each of the distinct cell types;
(b) a communication module; and
(c) a processing module comprising a cell ontogeny information manager configured to process cell ontogeny information requests of the relational database submitted by a user.

In certain embodiments, the cell ontogeny information manager requests qualifying information from a user prior to the user accessing the system.

In certain embodiments, the qualifying information is selected from the group consisting of: name, email address, affiliation, billing address, mailing address, company name, and job title.

In certain embodiments, the cell ontogeny information for each of the plurality of distinct cell types comprises an Embryome Identification Number (EIN), wherein the EIN comprises an alphanumeric designation for each of:
(i) the species of the organism;
(ii) the cell type; and
(iii) the embryonic stage of the cell type.

In certain embodiments, the relational database further comprises product information from a vendor related to one or more of the distinct cell types.

In certain embodiments, the product information from the vendor is selected from one or more of: cell lines, cell culture medium, antibodies, protein ligands, oligonucleotide probes, enzymes, enzyme assays, copyrighted images and/or text, proprietary data and/or data analysis, and cell type correlation algorithm(s).

In certain embodiments, the cell ontogeny content information manager is further configured to calculate at least one transaction fee when a user requests access to the product information.

In certain embodiments, the at least one transaction fee is calculated using at least one transaction rule.

In certain embodiments, the at least one transaction rule is based on one or more of: number of items ordered, a purchase amount, type of item purchased, payment method, identity of item ordered, identity of the user, and identity of the vendor.

In certain embodiments, the at least one transaction rule is drawn to determining revenue sharing between: the vendor, an administrators of the system, an operator of the system, or any combination thereof.

In certain embodiments, the at least one transaction fee is charged to: the user, the vendor, and any combination thereof.

In certain embodiments, the relational database comprises cell ontogeny information stored in a remote location.

In certain embodiments, the cell ontogeny content information manager is configured to be controlled by an administrator of the system.

In certain embodiments, the communication module is configured to provide for remote communication between the processing module and the user.

In certain embodiments, the communication module provides for a graphical user interface (GUI) between the user and the processing module.

In certain embodiments, the processing module is further configured to accept cell ontogeny information from the user and store it in the relational database.

In certain embodiments, the cell ontogeny information from the user can be accessed by a second user of the system.

In certain embodiments, access to the system by the user requires payment of a user fee.

Aspects of the invention include a method for providing cell ontogeny information that includes:
(a) providing a system for providing cell ontogeny information, the system comprising:
   (i) a relational database comprising cell ontogeny information for a plurality of distinct cell types of an organism, wherein the cell ontogeny information for each of the plurality of distinct cell types comprises:
      (1) a developmental age of the organism; and
      (2) one or more genes expressed in each of the distinct cell types;
   (ii) a communication module; and
   (iii) a processing module comprising a cell ontogeny content information manager configured to process cell ontogeny information requests of the relational database submitted by a user; and
(b) providing cell ontogeny information request to a user.

In certain embodiments, the system is accessed via the Internet.

In certain embodiments, the accessing is via a graphical user interface.

In certain embodiments, the accessing requires that the user provides qualifying information.

In certain embodiments, the relational database further comprises product information from a vendor related to one or more of the distinct cell types.

In certain embodiments, the product information from the vendor is selected from one or more of: cell lines, cell culture medium, antibodies, protein ligands, oligonucleotide probes, enzymes, enzyme assays, copyrighted images and/or text, proprietary data and/or data analysis, and cell type correlation algorithm(s).

In certain embodiments, the method further comprises receiving a cell ontogeny information request from the user.

In certain embodiments, the cell ontogeny information request is selected from: submitting cell ontogeny information, retrieving cell ontogeny information, retrieving product information, ordering a product from the vendor, commenting on cell ontogeny information stored in the database, and any combination thereof.

In certain embodiments, the method further comprises determining at least one transaction fee, wherein the at least one transaction fee is based on cell ontogeny information, product information, or both, retrieved by the user.

In certain embodiments, the at least one transaction fee is charged to at least one of: the user and the vendor.

In certain embodiments, the vendor operates and administers the system.

In certain embodiments, the vendor is a third party.

Aspects of the invention include a computer program product comprising a computer readable storage medium having a computer program stored thereon, where the computer program, when loaded onto a computer, operates the computer to:
(a) establish a cell ontogeny information relational database; and
(b) process cell ontogeny information requests of the relational database.

### BRIEF DESCRIPTION OF THE FIGURES

FIG. 1. An example of an Embryome Identification Number is shown.

FIG. 2. An exemplary cell ontological tree used in navigating the embryome database is shown.

FIG. 3. Schematically illustrates an exemplary system of the present invention.

### DEFINITIONS

As used herein, the term “relational database” or “data structure” (or equivalents) is intended to mean an organization of information, such as a physical or logical relationship among data elements, designed to support specific data manipulation functions, such as an algorithm. The term can include, for example, a list or other collection type of data elements that can be added, subtracted, combined or otherwise manipulated. Exemplarily, types of data structures include a list, linked-list, doubly linked-list, indexed list, table, matrix, queue, stack, heap, dictionary, flat file databases, relational databases, local databases, distributed databases, thin client databases and tree. The term also can include organizational structures of information that relate or correlate, for example, data elements from a plurality of data structures or other forms of data management structures. A specific example of information organized by a data structure of the invention is the association of a plurality of data elements relating to a gene, e.g., its sequence, expression level in one or more cell or tissue types, copy number, activity states (e.g., active or non-active in one or more tissues), its modified, processed and/or variant forms, splice variants encoded by the gene, the locations of introns and exons, functional domains, interactions with other molecules, function, sequence similarity to other probe sequences, etc. A data structure can be a recorded form of information (such as a list) or can contain additional information (e.g., annotations) regarding the information contained therein. A data structure can include pointers or links to resources external to the data structure (e.g., such as external databases). In one aspect, a data structure is embodied in a tangible form, e.g. is stored or represented in a tangible medium (such as a computer readable medium).

The term “object” refers to a unique concrete instance of an abstract data type, a class (that is, a conceptual structure including both data and the methods to access it) whose identity is separate from that of other objects, although it can “communicate” with them via messages. In some occasions, some objects can be conceived of as a subprogram which can communicate with others by receiving or giving instructions based on its, or the others' data or methods. Data can consist of numbers, literal strings, variables, references, etc. In addition to data, an object can include methods for manipulating data. In certain instances, an object may be viewed as a region of storage. In the present invention, an object typically includes a plurality of data elements and methods for manipulating such data elements.

A “relation” or “relationship” is an interaction between multiple data elements and/or data structures and/or objects. A list of properties may be attached to a relation. Such properties may include name, type, location, etc. A relation may be expressed as a link in a network diagram. Each data element may play a specific “role” in a relation.

As used herein, an “annotation” is a comment, explanation, note, link, or metadata about a data element, data structure or object, or a collection thereof. Annotations may include pointers to external objects or external data. An annotation may optionally include information about an author who created or modified the annotation, as well as information about when that creation or modification occurred. In one embodiment, a memory comprising a plurality of data structures organized by annotation category provides a database through which information from multiple databases, public or private, may be accessed, assembled, and processed.

The terms “system” and “computer-based system” refer to the hardware means, software means, and data storage means used to analyze the information of the present invention. The minimum hardware of the computer-based systems of the present invention comprises a central processing unit (CPU), input means, output means, and data storage means. As such, any convenient computer-based system may be employed in the present invention. The data storage means may comprise any manufacture comprising a recording of the present information as described above, or a memory access means that can access such a manufacture.

A “processor” references any hardware and/or software combination which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, USB, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory. With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any convenient method. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

In certain embodiments, a system includes hardware components which take the form of one or more platforms, e.g., in the form of servers, such that any functional elements of the system, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any convenient type of computer platform, e.g., such as a server, main-frame computer, a work station, etc. Where more than one platform is present, the platforms may be connected via any convenient type of connection, e.g., cabling or other communication system including wireless systems, either networked or otherwise. Where more than one platform is present, the platforms may be co-located or they may be physically separated. Various operating systems may be employed on any of the computer platforms, where representative operating systems include Windows, Sun Solaris, Linux, OS/400, Compaq Tru64 Unix, SGI IRIX, Siemens Reliant Unix, and others. The functional elements of system may also be implemented in accordance with a variety of software facilitators, platforms, or other convenient method. Exemplary database application software packages include those provided by SAP, Peoplesoft, BAAN, and Oracle.

Items of data are “linked” to one another in a memory when the same data input (for example, filename or directory name or search term) retrieves the linked items (in a same file or not) or an input of one or more of the linked items retrieves one or more of the others.

By “remote location,” it is meant a location other than the location of a first element of interest. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information means transmitting the data representing that information as signals (e.g., electrical, optical, radio signals, and the like) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

### DETAILED DESCRIPTION OF THE INVENTION

As summarized above, aspects of the invention are drawn to cell ontogeny information systems and methods for using the same.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed. It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Aspects of the invention include systems for storing, organizing and retrieving cell ontogeny information and methods for using the same.

Representative embodiments of the subject systems generally include the following components: (a) a relational database comprising cell ontogeny information for a plurality of distinct cell types of an organism, wherein the cell ontogeny information for each of the plurality of distinct cell types includes: (i) a developmental age of the organism; and (ii) one or more genes expressed in each of the distinct cell types; (b) a communication module for facilitating information transfer between the system and one or more users, e.g., via a user computer, as described below; and (c) a processing module for performing one or more tasks in response to request information received via the communications module of the system submitted by a user. In certain embodiments, the processing module includes a cell ontogeny content information manager configured to process cell ontogeny information requests of the relational database. In certain embodiments (and as described in further detail below), the cell ontogeny information manager is configured to receive cell ontogeny information from a user that is saved to the relational database. Saving information to the relational database may be regulated by one or more of: an administrator of the system, registered users of the system, users of the system having approved access to the relational database by the system administrator. In certain embodiments, the administrator of the system and/or administrator approved or registered users may comment on or remove cell ontogeny information from the relational database.

In representative embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet.

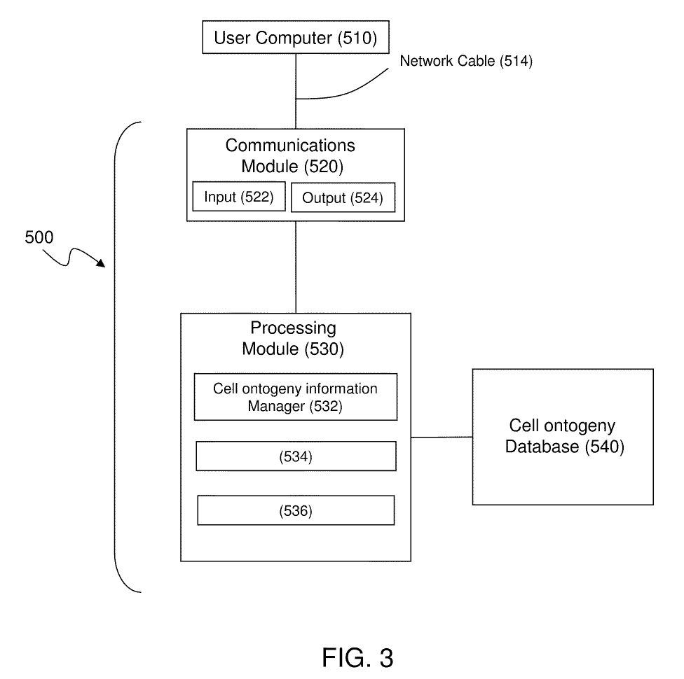

FIG. 3 provides a view of a representative cell ontogeny information exchange system according to an embodiment of the subject invention. In FIG. 3, system 500 includes communications module 520 and processing module 530, where each module may be present on the same or different platforms, e.g., servers, as described above. The communications module includes the input manager 522 and output manager 524 functional elements.

Input manager 522 receives information, e.g., cell ontogeny request information, from a user e.g., over the Internet. Input manager 522 processes and forwards this information to the processing module 530. These functions are implemented using any convenient method or technique. Another of the functional elements of communications module 520 is output manager 524. Output manager 524 provides information assembled by processing module 530, e.g., cell ontogeny information or product information, to a user, e.g., over the Internet. The presentation of data by the output manager may be implemented in accordance with any convenient methods or techniques. As some examples, data may include SQL, HTML or XML documents, email or other files, or data in other forms. The data may include Internet URL addresses so that a user may retrieve additional SQL, HTML, XML, or other documents or data from remote sources.

The communications module 520 may be operatively connected to a user computer 510, which provides a vehicle for a user to interact with the system 500. User computer 510, shown in FIG. 3, may be a computing device specially designed and configured to support and execute any of a multitude of different applications. Computer 510 also may be any of a variety of types of general-purpose computers such as a personal computer, network server, workstation, or other computer platform now or later developed. Computer 510 may include components such as a processor, an operating system, a graphical user interface (GUI) controller, a system memory, memory storage devices, and input-output controllers. There are many possible configurations of the components of computer 510 and some components are not listed above, such as cache memory, a data backup unit, and many other devices. In certain embodiments, a computer program product is described comprising a computer usable medium having control logic (computer software program, including program code) stored therein. The control logic, when executed by the processor of the computer, causes the processor to perform functions described herein. In other embodiments, some functions are implemented primarily in hardware using, for example, a hardware state machine. Implementation of the hardware state machine so as to perform the functions described herein may be accomplished using any convenient method and techniques.

During use, a user employs the user computer to enter information into and retrieve information from the system. As shown in FIG. 3, computer 510 is coupled via network cable 514 to the system 500. Additional computers of other users and/or administrators or operators of the system in a local or wide-area network including an Intranet, the Internet, or any other network may also be coupled to system 500 via cable 514. It will be understood that cable 514 is merely representative of any type of network connectivity, which may involve cables, transmitters, relay stations, network servers, wireless communication devices, and many other components not shown suitable for the purpose. Via user computer 510, a user may operate a web browser served by a user-side Internet client to communicate via Internet with system 500. System 500 may similarly be in communication over Internet with other users, networks of users, and/or system administrators, as desired.

As reviewed above, the system includes various functional elements that carry out specific tasks on the platforms in response to information introduced into the system by one or more users. In FIG. 3, elements 532, 534 and 536 represent three different functional elements of processing module 530. While three different functional elements are shown, it is noted that the number of functional elements may be more or less, depending on the particular embodiment of the invention.

Representative functional elements that may be carried out by the processing module are now reviewed in greater detail below.

In certain embodiments, the subject system includes a cell ontogeny relational database 540 and a cell ontogeny information manager 532 as part of the processing module 530 which is configured to perform functions relating to management of cell ontogeny information in database 540.

The cell ontogeny relational database (sometimes referred to as “database” or “relational database” or variations thereof) comprises cell ontogeny information that includes any number of types of cellular information, including, but not limited to, one or more of: species of organism, cell category, developmental stage, temporal stage, germ layer, a physical location, tissue type, cell characteristic or morphology (e.g., size, shape, motility, granularity, etc.), growth characteristic or cell cycle profile (e.g., proliferative, senescent, apoptotic, etc.), and gene expression level in the cell (e.g., for one or more genes). In certain embodiments, 90% or more of the ontological information in the database is specific for individual cell types rather than for a tissue as a whole. This type of database provides cell-specific information that is not “contaminated” by other cells present in a tissue, which is of particular interest when categorizing cells based on gene expression profiles (as discussed below).

In certain embodiments, the cell ontogeny information manager is configured to process cell ontogeny information requests from a user. Cell ontogeny information requests include both submissions of cell ontogeny information to the database and queries for cell ontogeny information from the database. Queries for cell ontogeny information from a user (or users) can be based on any number of types of cellular information, including, but not limited to one or more of: species of organism, cell category, developmental stage, temporal stage, germ layer, a physical location, tissue type, cell characteristic or morphology (e.g., size, shape, motility, granularity, etc.), growth characteristic or cell cycle profile (e.g., proliferative, senescent, apoptotic, etc.), and gene expression level (e.g., for one or more genes). A gene expression level query can include relative and/or quantitative data and can be based on any relevant expression readout, e.g., mRNA and/or protein expression level. Queries of the system can be entered by a user in any convenient format, including direct entry (e.g., by filling in fields displayed on a GUI of the system), selecting query terms from menus (e.g., drop-down menus), uploading query information from user data files (e.g., gene expression data from a gene expression microarray experiment).

Categorization of a cell type often requires a correlation of the expression level of multiple specific genes (e.g., 10 or more, 100 or more, 500 or more, 1,000 or more, etc.). Given the ability of researchers to obtain the levels of large numbers of genes in a cell using nucleic acid and protein-based microarrays (including arrays for interrogating up to the entire genome), aspects of the present invention make it is possible to positively identify cell types through a correlation of global gene expression. Therefore, in certain aspects of the invention, a user can input into the system gene expression data for a cell of interest and the system will, by correlating this gene expression with all of the gene expression information for the cell types in the database, determine its place on the ontological tree.

In certain embodiments, a gene expression level query of the system involves the correlation by the system of gene expression data entered by a user (in the form of a query, as described above) with gene expression data in the relational database. The system will return results that show the cellular ontogeny of cells having similar gene expression profiles. In certain embodiments, the system returns a list of candidate cell ontological matches for the query from which the user can review. In certain embodiments, a user can refine a query after receiving results by adding or removing specific query information.

In certain embodiments, the user selects which, if any, of the results returned in response to the query to save. In certain embodiments, the selected results are saved in a user domain. In certain embodiments, a graphical display of the returned results (e.g., in the form of web page content on a graphical user interface in communication with the output manager) may include a box that when selected by a user (e.g., by clicking in the box) indicates that the user wants this result to be saved in the user domain. Any convenient method for selecting a displayed query result (or multiple results) may be employed. Results that have been selected by the user to be saved are stored by the system in the user domain, e.g., by selecting/clicking on a “save” icon displayed on the graphical display of the results. In certain embodiments, user queries are saved in the user domain, e.g., in the form of a user query history. In certain embodiments, queries and/or results of the queries from a first user may be accessed by a second user, e.g., by the first user allowing access to all or part of his user domain to the second user. In certain embodiments, a user domain will have designated “public” and “private” areas for saving information, where information in the “public” area is accessible by one or more second users of the system.

In certain embodiments, the cell ontogeny information manager is configured to approve a user to access the system. In certain embodiments, the cell ontogeny information submitted by a user is proprietary, and may be accessed by another user only under certain restricted circumstances (e.g., for a fee or by permission by the submitting user).

In certain embodiments, the database contains cell ontogeny information that is controlled by the administrator/operator of the system, including information submitted by a user. In certain embodiments, the database contains user-administered cell ontogeny information. For example, a user submitting cell ontogeny information to the system may be a commercial provider (or vendor) of a proprietary cell line that can be made available to another user upon request (information provided by a vendor is also referred to herein as product information). In certain embodiments, a user administered proprietary array content information database is linked to the system via the internet.

A system may be set up to function on one or more commercial models which employ one or more of these (or other) transaction fee/revenue sharing schemes. For example, a system of the present invention can be set up in which free access is granted to the site by a user but particular cell ontogeny information (e.g., microarray data, clinical trial information, online correlation algorithms, copyrighted figures from publications, etc.) are sold for a fee. As another example, the system may be configured to allow a user access to specific types of categories of information for a set fee. It is to be understood that there are myriad ways to configure a user's access to cell ontogeny information of systems of the invention, and that the foregoing are merely exemplary.

In certain embodiments, the system is configured to allow a user of the system to submit comments on cell ontogeny information in the database (e.g., an entry submitted by another user), which can vary widely (e.g., a gene that is of particular use in identifying a cell type of interest). In certain embodiments, the comments are displayed to a user of the system when viewing the detailed information of the cell ontogeny information (e.g., when a user selects a specific hyperlinked query result to see more cell ontogeny information). In certain embodiments, an administrator of the system regulates the entry of a comment into the system (e.g., allows, rejects, or modifies a comment submitted to the system). In certain embodiments, the user that submitted the cell ontogeny information (or product information) may provide a response to the comment that will be displayed along with the comment submitted by another user. In certain embodiments, a submitting user may exclude other users form commenting on his/her proprietary array content information submission.

In certain embodiments, the system is further configured to include a processing module with one or more of the following additional functionalities:
(i) a security manager configured to control information transfer in a predetermined manner between a user, an administrator, a vendor, or any combination thereof;
(ii) a vendor manager configured to provide access by a user to a service or product provided by at least one vendor; and
(iii) a rules manager configured to regulate permissions for a user based on the user's actions in the system (e.g., to regulate a user's access to cell ontogeny information).

The output manager 524 can provide a user with information regarding cell ontogeny information and/or product information in a number of ways. In certain embodiments, the information is provided in the form of an email. In certain embodiments, the information is provided in the form of web page content on a graphical user interface (GUI) in communication with the output manager. In certain embodiments, cell ontogeny information is provided as tables of gene expression information for one or more distinct cell types of interest (e.g., present in an ontological tree, as described in more detail below). In certain embodiments, the system returns information relating to products or regents related to the cell or cells of interest, e.g., genes, cell lines that express those genes, cell lines that express specific proteins, etc. In certain embodiments, links to vendors of such products or reagents are displayed.

In certain embodiments, the information provided to a user (e.g., on a web page) includes the user with an option to select for purchase one or more products provided by a vendor. In certain embodiments, the web page content includes fields for inputting customer information, which, in certain embodiments, is stored in a memory of the system.

In certain embodiments, a system of the invention employs a graphical representation cell ontogeny as the user interface (e.g., on a GUI). In certain embodiments, the graphical representation employed is a cell ontological tree that shows the spatial, temporal and hierarchical relationships between cells of a developing organism. In certain embodiments, a cell ontological tree is a hierarchical branching tree of all (or most) cell types in a developing organism of interest and is utilized to organize the data in the relational database as well as to aid the researcher in identifying the cell type of interest. In certain embodiments, the cell ontological tree may be updated and revised based on information from other sources (e.g., users of the system, publications, public and private databases, public and private data, etc.). In certain embodiments, the cell ontological tree used in the system of database is presented graphically on the front page to aid in the navigation of the site. FIG. 2 provides an exemplary ontological tree that finds use in navigating the database.

The system and methods of the present invention may be employed for virtually any organism, including but not limited to: mouse (Mus musculus), rat, human (Homo sapiens), primates, and other vertebrate species including, but not limited to the chicken (Gallus gallus).

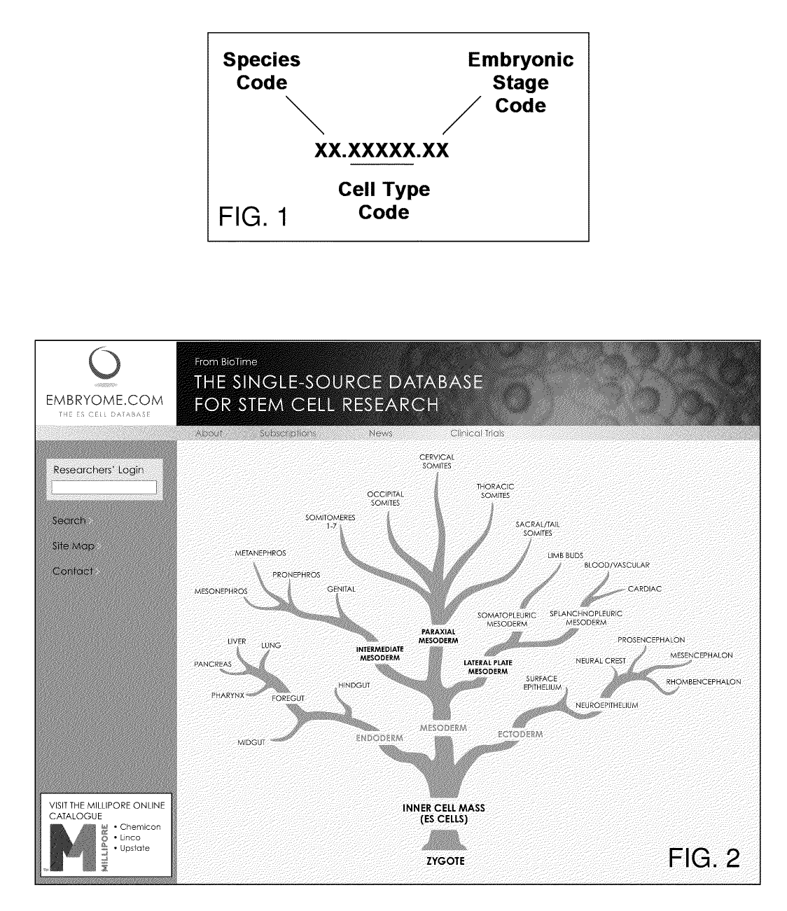

As noted above, a cell ontological tree places each cell type in both a spatial orientation (where it is on the tree, what cell type it originated from and what cell types it can differentiate into), but also identifies where the cell resides on a temporal scale in the normal development of the organism. In certain embodiments, this is accomplished by assigning each cell type an Embryome Identification Number (EIN). This number combines an alphanumeric code for the species, the cell type, and the embryonic stage of the embryo. An example of such an EIN is shown in FIG. 1. The EIN in FIG. 1 includes a two digit species code, a five digit cell type code and a two digit embryonic stage code. It is to be understood that other EIN configurations can be used, and as such, the EIN of FIG. 2 is not meant to be limiting.

Table 1 provides exemplary species and cell type codes.

TABLE 1

| Embryome | | | |
|---|---|---|---|
| Identification | | | |
| Number (EIN) | Species | Cell Category | Germ Layer |
| 01.XXXXX.XX | Mus musculus | | |
| 02.XXXXX.XX | Homo sapiens | | |

| | | |
|---|---|---|
| XX.00010.XX-XX.00999.XX | Embryonic & Germ-Line Cells | Embryonic/Germ- |
| | | Line |
| XX.01000.XX-XX.01999.XX | Trophectodermal | Extraembryonic |
| | | Cells |
| XX.02000.XX-XX.02999.XX | Extraembryonic Endoderm | Extraembryonic |
| | | Cells |
| XX.03000.XX-XX.03999.XX | Extraembryonic Mesoderm | Extraembryonic |
| | | Cells |
| XX.04000.XX-XX.04999.XX | Extraembryonic Ectoderm | Extraembryonic |
| | | Cells |
| XX.05000.XX-XX.12999.XX | Endoderm - Foregut | Endoderm |
| XX.13000.XX-XX.19999.XX | Endoderm - Midgut | Endoderm |
| XX.20000.XX-XX.24999.XX | Endoderm - Hindgut | Endoderm |
| XX.25000.XX-XX.28999.XX | Mesoderm - Paraxial | Mesoderm |
| XX.29000.XX-XX.32999.XX | Mesoderm - Notochord/Prechordal | Mesoderm |
| | Plate | |
| XX.33000.XX-XX.39999.XX | Mesoderm - Intermediate | Mesoderm |
| XX.40000.XX-XX.49999.XX | Mesoderm - Lateral Plate | Mesoderm |
| XX.50000.XX-XX.59999.XX | Ectoderm - Prosencephalon | Ectoderm |
| XX.60000.XX-XX.65999.XX | Ectoderm - Mesencephalon | Ectoderm |
| XX.66000.XX-XX.74999.XX | Ectoderm - Rhombencephalon | Ectoderm |
| XX.75000.XX-XX.84999.XX | Neural Crest - Cranial | Ectoderm |
| XX.85000.XX-XX.94999.XX | Neural Crest - Occipital-Spinal | Ectoderm |
| XX.95000.XX-XX.95999.XX | Surface Ectoderm | Ectoderm |
| XX.96000.XX-XX.99999.XX | Uncharacterized | Uncharacterized |

Developmental information on the anatomy of some organisms is available, and in some cases linked to gene expression data [see, e.g. http(colon)//genex(dot)hgu(dot)mrc(dot)ac(dot)uk; and http(colon)//www(dot)informatics(dot)jax(dot)org/searches/gxdindex_form(dot)shtml]. Such databases, however, are based on anatomical trees that do not provide cellular-level resolution of ontogeny as described herein. For example, the mouse anatomical tree created by the EMAP project [which can be found at http(colon)//genex(dot)hgu(dot)mrc(dot)ac(dot)uk/Emage/database/emageIntro(dot)html] may provide information that a specific gene is expressed in a tissue (e.g., Wilm's tumor gene is expressed in the kidney), but not provide information or data related to which specific cell in the tissue expresses this gene (e.g., if the cell expressing Wilm's tumor gene in the kidney is a collecting duct epithelial cell, a Bowman's capsule cell, etc.).

As noted above, certain embodiments of the subject invention include relational databases in which 90% or more of the ontological information in the database is specific for individual cell types rather than for a tissue as a whole. This type of database provides cell-specific information that is not “contaminated” by other cells present in a tissue, which is of particular interest when categorizing cells based on gene expression profiles. For example, gene expression data for a tissue as a whole (or a tissue sub-section having many cell types) will provide averaged gene expression levels across all cells in the tissue (e.g., including immune cells, vascular cells, or cells of other origin). These averaged gene expression values can confound placing a specific isolated (or purified) cell of a user into its appropriate place on an ontological tree based on the gene expression of the isolated/purified cell (e.g., isolated/purified adult cells, developmental intermediates, and embryonic or adult stem and progenitor cells, etc.). For example, systems and methods according this aspect of the present invention find use in the categorization of clonal embryonic progenitors as described in West et al, (2008) Regenerative Medicine 3(3):287-308 entitled “The ACTCellerate initiative: large-scale combinatorial cloning of novel human embryonic stem cell derivatives”(incorporated by reference herein in its entirety).

Using specific, individual cell types as the base components and linking these cell types in their ontological order in a comprehensive, interactive ontological tree has not been described. As such, the present invention provides a valuable tool for cellular ontogeny identification that is critical to progress in the field of regenerative medicine.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A cell ontogeny information system, said system comprising:
(a) a relational database comprising cell ontogeny information for a plurality of distinct cell types of an organism, wherein said cell ontogeny information for each of said plurality of distinct cell types comprises:
(i) a developmental age of said organism; and
(ii) one or more genes expressed in each of said distinct cell types;
(b) a communication module; and
(c) a processing module comprising a cell ontogeny information manager configured to process cell ontogeny information requests of said relational database submitted by a user.

2. The system of claim 1, wherein said cell ontogeny information for each of said plurality of distinct cell types comprises an Embryome Identification Number (EIN), wherein said EIN comprises an alphanumeric designation for each of:
(i) the species of said organism;
(ii) the cell type; and
(iii) the embryonic stage of said cell type.

3. The system of claim 1, wherein said relational database further comprises product information from a vendor related to one or more of said distinct cell types.

4. The system of claim 3, wherein said product information from said vendor is selected from one or more of: cell lines, cell culture medium, antibodies, protein ligands, oligonucleotide probes, enzymes, enzyme assays, copyrighted images and/or text, proprietary data and/or data analysis, and cell type correlation algorithm(s).

5. The system of claim 1, wherein said relational database comprises cell ontogeny information stored in a remote location.

6. The system of claim 1, wherein 90% or more of said cell ontogeny information in said relational database is specific for individual cell types rather than for a tissue as a whole.

7. The system of claim 1, wherein said cell ontogeny content information manager is configured to be controlled by an administrator of said system.

8. The system of claim 1, wherein said communication module is configured to provide for remote communication between said processing module and said user.

9. The system of claim 1, wherein said communication module provides for a graphical user interface (GUI) between said user and said processing module.

10. The system of claim 1, wherein said processing module is further configured to accept cell ontogeny information from said user and store it in said relational database.

11. The system of claim 10, wherein said cell ontogeny information from said user can be accessed by a second user of said system.

12. The system of claim 1, wherein access to said system by said user requires payment of a user fee.

13. A method for providing cell ontogeny information, said method comprising:
(a) providing a system for providing cell ontogeny information, said system comprising:
(i) a relational database comprising cell ontogeny information for a plurality of distinct cell types of an organism, wherein said cell ontogeny information for each of said plurality of distinct cell types comprises:
(1) a developmental age of said organism; and
(2) one or more genes expressed in each of said distinct cell types;
(ii) a communication module; and
(iii) a processing module comprising a cell ontogeny content information manager configured to process cell ontogeny information requests of said relational database submitted by a user; and
(b) providing cell ontogeny information from said relational database to a user.

14. The method of claim 13, wherein said method further comprises receiving a cell ontogeny information request from said user.

15. The method of claim 14, wherein said cell ontogeny information request is selected from: submitting cell ontogeny information, retrieving cell ontogeny information, retrieving product information, ordering a product from said vendor, commenting on cell ontogeny information stored in said database, and any combination thereof.

16. The method of claim 15, wherein said system is accessed by said user via the Internet using a graphical user interface.

17. The method of claim 13, wherein said relational database further comprises product information from a vendor related to one or more of said distinct cell types, wherein said method further comprises providing said product information to said user.

18. The method of claim 17, wherein said product information from said vendor is selected from one or more of: cell lines, cell culture medium, antibodies, protein ligands, oligonucleotide probes, enzymes, enzyme assays, copyrighted images and/or text, proprietary data and/or data analysis, and cell type correlation algorithm(s).

19. The method of claim 17, wherein said method further comprises determining at least one transaction fee, wherein said at least one transaction fee is based on cell ontogeny information, product information, or both, provided to said user.

20. A computer program product comprising a computer readable storage medium having a computer program stored thereon, wherein said computer program, when loaded onto a computer, operates said computer to:
(a) establish a cell ontogeny information relational database; and
(b) process cell ontogeny information requests of said relational database.
